(19) United States
(12) Patent Application Publication
(10) Pub. No.: US 2022/0250815 A1
(43) Pub. Date: Aug. 11, 2022

(54) TAMPER-EVIDENT RECLOSABLE PACKAGES

(71) Applicant: C.L.P Industries Ltd., Negba (IL)

(72) Inventors: Lilia SHPAKOVSKY, Yavne (IL); Yakir FARJUN, Shapira Center (IL)

(21) Appl. No.: 17/189,446

(22) Filed: Mar. 2, 2021

(30) Foreign Application Priority Data
Feb. 11, 2021 (IL) 280825

(51) Int. Cl. B65D 55/02; B65D 51/24; B65D 77/20

(52) U.S. Cl. CPC B65D 55/026; B65D 51/248; B65D 2203/12; B65D 2401/55; B65D 77/2096

(57) ABSTRACT

Tamper-evident, re-closable lidding films and systems thereof that makes unauthorized access to a protected object easily detected. Color-changing anti-tampering packages and methods thereof.

### FIELD OF THE INVENTION

The present invention generally pertains to tamper-evident, namely a reclosable lidding film that makes unauthorized access to the protected object easily detected. More specifically, the invention relates to a color-changing anti-tampering packages and methods thereof.

### BACKGROUND OF THE INVENTION

Counterfeiting activities are ubiquitous in industry affecting products from pharmaceuticals and medical equipment through to machine, electrical, automotive and aircraft parts, clothing, fashion items, movies, computer software and cigarettes, see Soon, Jan Mei, and Louise Manning. “Developing anti-counterfeiting measures: the role of smart packaging.” Food Research International (2019): 135-143. The Global Brand Counterfeiting Report (2018) estimates that the value of global counterfeiting is $1.2 trillion per annum and will reach $1.82 trillion by 2020 with online distribution of counterfeit products being in the region of $323 billion 31 annually, see currently available link: https://www.researchandmarkets.com/research/7j712n/global_brand?w=4. More than that, food safety is a major factor affecting public health and the well-being of society; and food tampering hence rises much concerns regarding food, pharmaceuticals and other products' originality and safety. One approach for avoiding counterfeiting and tampering is related with colors, dyes and inks, such as those technologies disclosed in U.S. Pat. Nos. 4,972,953; 4,837,061; 5,082,702A 5,474,194; US20030200725 and U.S. Pat. No. 10,625,913. Unfortunately, the tamper-evident techniques mentioned above are easily imitated with rapid advancement of technology. Thus, persistent efforts should be devoted to exploring advanced anti-counterfeiting technologies with low cost and high-level security to deter tampering.

### SUMMARY OF THE INVENTION

It is hence an object of the invention to disclose a tamper-evident re-usable seal device, to enhance security of assets to be protected, in order to inhibit attempts to break into the asset, or to remove the asset. The a tamper-evident reclosable package (100) is characterized by a reclosable lidding film 10 configure by means of shape and size to cover a matching tray 20 that having a lip or rim 21; the reclosable lid 10 is a multilayered flexible or semiflexible film comprises at top most position, a transparent layer (12); at least one first printing ink 13 underneath; adhesive layer 14; a multilayer 19, comprising a polymeric layer of reclosable properties; and bottom most a sealing layer 18; the lip 21 is covered by at least one second printing ink 22.

Another object of the invention is to disclose a tamper-evident reclosable package as defined above, wherein lidding film 10 is a multilayered film comprises a film (12) selected from a group consisting of polyethylene terephthalate (PET), polyamide (PA), amorphous polyethylene terephthalate (APET), polyethylene terephthalate glycol-modified (PETG), polypropylene (PP), bi-axially orientated PP (BOPP), polyoxymethylene (POM) and any mixture and derivatives thereof.

Another object of the invention is to disclose a tamper-evident reclosable package as defined in any of the above, wherein multilayer 19 comprising plastic, including polyethylene, LDPE.

Another object of the invention is to disclose a tamper-evident reclosable package as defined in any of the above, wherein at least one of the following is held true: (a) thickness of the transparent layer 12; (b) thickness of the at least one first printing ink 13 is ranging e.g., from about 1 to about 5 μm is ranging from about 1 to about 5 μm; (c) thickness of the of the adhesive layer 14 is ranging e.g., from about 1.5 to about 5 μm; (d) total thickness of the a multilayer 19; and (e) thickness of the at least one second printing ink 22 is ranging e.g., from about 1 to about 5 μm.

Another object of the invention is to disclose a tamper-evident reclosable package as defined above, wherein either or both the first and second insignia are selected from a group consisting of alphanumeric, color(s), barcode, symbol, mark, magnetically readable signal and any combination thereof.

Another object of the invention is to disclose a method of manufacturing a tamper-evident reclosable package (100); the method comprise steps of configuring by means of shape and size a reclosable lidding film 10 to cover a matching tray 20, e.g., made of APET, PP or PE, having a lip or rim 21; providing the reclosable lid 10 as a multilayer film comprising a top most transparent layer (12); underneath providing at least one first printing ink 13; adhesive layer 14; a multilayer 19, a polymeric layer of reclosable properties; and bottom most sealing layer 18; and covering at least a portion of the lip 21 by at least one second printing ink 22.

Another object of the invention is to disclose method of manufacturing a tamper-evident reclosable package as defined above, wherein lidding film 10 is a multilayered film comprises a film (12) selected from a group consisting of PET, PA, APET, GPET, PP, BOPP, POM, POM, and any mixture and derivative thereof.

Another object is to disclose the method as defined the above, wherein multilayer 19 comprising thermoplastic plastic, including polyethylene in general and specifically LDPE. Another object is to disclose the method as defined in any of the above, wherein at least one of the following is held true: (a) thickness of the transparent layer 12; (b) thickness of the at least one first printing ink 13 is ranging from about 1 to about 5 μm is ranging from about 2 to about 3.5 μm; (c) thickness of the of the adhesive layer 14 is ranging from about 1.5 to about 3 μm; (d) total thickness of the a multilayer 19, is ranging from about 40 to about 60 μm; and (e) thickness of the at least one second printing ink 22 is ranging from about 1 to about 5 μm. Another object is to disclose the method as defined in any of the above, wherein either or both the first and second insignia are selected from a group consisting of alphanumeric, color(s), barcode, symbol, mark, magnetically readable signal and any combination thereof. Another object is to disclose the method as defined in any of the above, wherein lidding film 10 is a multilayered film comprises a film (12) selected from a group consisting of PET, PA, APET, GPET, PP, BOPP, POM, and any mixture and derivative thereof. Another object is to disclose the method as defined in any of the above, wherein multilayer 19 comprising thermoplastic plastic, including polyethylene and specifically: LDPE. Another object is to disclose the method as defined in any of the above, wherein at least one of the following is held true: thickness of the transparent layer 12; thickness of the at least one first printing ink 13 is ranging from about 1 to about 5 μm; thickness of the of the adhesive layer 14 is ranging from about 1.5 to about 5 μm; total thickness of the a multilayer 19, is ranging from about 40 to about 60 μm; and thickness of the at least one second printing ink 22 is ranging from about 1 to about 5 μm. Another object is to disclose the method as defined in any of the above, wherein the either or both the first and second insignia are selected from a group consisting of alphanumeric, color(s), barcode, symbol, mark, magnetically readable signal and any combination thereof.

Another object of the invention is to disclose method of indicating of tampering of a reclosable package (100). The method comprising steps as follows: providing a reclosable lidding film 10, configured by means of shape and size to cover a matching tray 20 having a lip or rim 21; the reclosable lidding film 10 is a multilayer comprises at top most position, a transparent layer (12); at least one first printing ink 13 underneath; adhesive layer 14; a multilayer 19 comprising a polymer-based layer, a polymeric layer of reclosable properties; and bottom most a sealing layer 18; the lip 21 covered by at least one second printing ink 22; at an initial configuration provided mechanically in the factory, hermetically sealing tray 20 by the lidding film, e.g., so gap 41 between lidding film and lip is zero or narrow than about 1.2 μm; thereby stacking the at least one first printing ink having a first insignia with the at least one second printing ink having a second insignia; so that the first and second insignia are concurrently provided a first visual indication of “non-tampered” (“never opened”) at top of at least one portion of lip 11; at a second configuration, peeling the lidding film, at a first time, from at least one portion of the lip; and at a third configuration, when lidding film is reclosing the tray in a non-hermetically manner, e.g., so gap 42 between lidding film and lip is wider than e.g., about 1.2 μm, showing the second insignia as the second visual indication of “tampered” (i.e., opened) at top of at least one portion of lip 11. Another object is to disclose the method as defined the above, wherein multilayer 19 comprising thermoplastic plastic, including polyethylene, and specifically: LDPE. Another object is to disclose the method as defined in any of the above, wherein at least one of the following is held true: (a) thickness of the transparent layer 12; (b) thickness of the at least one first printing ink 13 is ranging from about 1 to about 5 μm; (c) thickness of the of the adhesive layer 14 is ranging from about 1.5 to about 5 μm; (d) total thickness of the a multilayer 19, is ranging e.g., from 40 to 60 μm; and (e) thickness of the at least one second printing ink 22 is ranging from about 1 to about 5 μm. Another object is to disclose the method as defined in any of the above, wherein either or both the first and second insignia are selected from a group consisting of alphanumeric, color(s), barcode, symbol, mark, magnetically readable signal and any combination thereof. Another object is to disclose the method as defined in any of the above, wherein lidding film 10 is a multilayered film comprises a film (12) selected from a group consisting of PET, PA, APET, GPET, PP, BOPP, POM, and any mixture and derivative thereof. Another object is to disclose the method as defined in any of the above, wherein multilayer 19 comprising thermoplastic plastic, including polyethylene and specially: LDPE. Another object is to disclose the method as defined in any of the above, wherein at least one of the following is held true: (a) thickness of the transparent layer 12; (b) thickness of the at least one first printing ink 13 is ranging from about 1 to about 5 μm; (c) thickness of the of the adhesive layer 14 is ranging from about 1.5 to about 5 μm; (d) total thickness of the a multilayer 19, is ranging from 40 to 60 μm; and (e) thickness of the at least one second printing ink 22 is ranging from about 1 to about 5 μm. Another object is to disclose the method as defined in any of the above, wherein the either or both the first and second insignia are selected from a group consisting of alphanumeric, color(s), barcode, symbol, mark, magnetically readable signal and any combination thereof.

### DETAILED DESCRIPTION OF THE PREFERRED EMBODIMENTS

The accompanying drawings, which are included to provide a further understanding of the invention and are incorporated in and constitute a part of this specification, illustrate embodiments of the invention and together with the description serve to explain the principles of the invention wherein:

FIGS. 1 to 4 present schematic representations of the tamper-evident package according to an embodiment of the present invention;

Photos 5a and 5b depict a tamper-evident package according to another embodiment of the present invention; and

FIG. 6 schematically presents a multilayered structure of a tamper-evident package according to another embodiment of the present invention.

### DETAILED DESCRIPTION OF THE PREFERRED EMBODIMENTS

The following description is provided, alongside all chapters of the present invention, so as to enable any person skilled in the art to make use of the invention and sets forth the best modes contemplated by the inventor of carrying out this invention. Various modifications, however, are adapted to remain apparent to those skilled in the art, since the generic principles of the present invention have been defined specifically to provide compositions and methods.

Unless otherwise stated, with reference to numerical quantities, the term “about” refers to a tolerance of ±25% of the stated nominal values. Unless otherwise stated, all numerical ranges are inclusive of the stated limits of the range. As used herein, the term “alphanumeric” means consisting of both letters, numbers, punctuation marks, and mathematical symbols. “Alphanumeric” excludes band-like markings. The term “obscure” means conceal or hide from view, to a sufficient extent, as by or as if by covering wholly or in part, such that indicia are incapable of providing a readable message. The term “identical” means having such close resemblance and such minor difference as to be essentially the same. The term “split” means separated from end to end such that the monolayer film is converted to a bilayer film. Unless otherwise stated, the term “food” refers to substances intended to be consumed by humans in unaltered, prepared or processed form. As used throughout this application, the term “film” refers to a plastic web of any thickness and is not limited to a plastic web having a thickness of less than about 10 mil. The term “sheet” refers to a plastic web of any thickness and is not limited to a plastic web having a thickness of greater than about 10 mil. As used throughout this application, the term “package” refers to any device used to wholly or partially surround an item. A package may take many various forms. Hence for example, the term “package” may include flexible, semi flexible or rigid envelop, container or pouches that wholly surround an item (or items) to be packaged; the term “package” may also include films that partially surround an item (or items) to be packaged and, when used in conjunction with another material (such as a tray, e.g., food-, medicaments-, or cosmetics-containing tray), wholly surround an item (or items). As used herein, the term “packaging” also refers to packages made from such products, i.e. containers or sleeves, by placing the product in the product and welding the product, as a result of which the thermoshrinkable multilayer film of which the packaging container is made completely surrounds the product. Used in the invention, the term “flexible container” refers to bags with mechanical seal, side seal, L-shaped seal, U-shaped seal (also called “bags”), side folds, internally welded shells and seamless shells. Used in the invention, the term “package” also refers to a packaging container having an open top, side edges and a lower edge. The term “package” refers to flat bags, bags, shells (seamless shells and internally welded shells, including lap-welded shells, shells with welded edges and butt-welded inside shells with tape for joining from the inside). As used throughout this application, the term “multilayer” refers to a plurality of layers in a single structure generally in the form of a film, sheet or web which may be made from a polymeric material or a non-polymeric material bonded together by any conventional means known in the art (i.e., coextrusion, lamination, coating or blends of such). The multilayer film described in the present application comprises a film including as many layers as desired but at least two layers. As used throughout this application, the term “layer” refers to a discrete film or sheet component which may or may not be coextensive with the film or sheet but has substantially uniform composition. In referring to a monolayer film, “film,” “sheet” and “layer” are synonymous. As used throughout this application, the term “flexible” refers to a characteristic of easily yielding without breaking, apt to readily give way under pressure without breaking, able to readily change shape without breaking r able to readily bend without breaking. As used throughout this application, the term “semi-rigid” refers to a characteristic of rigid to some degree or in some parts stiff and solid, but not inflexible. A semi-rigid material may be apt to give way under pressure without breaking, may be able to bend without breaking or may be able to change shape without breaking but not to the same degree as a flexible material. s used throughout this application, the term “polymer” refers to a material which is the product of a polymerization or copolymerization reaction of natural, synthetic or combined natural and synthetic monomers and/or co-monomers and is inclusive of homopolymers, copolymers, terpolymers, etc. In general, the layers of the multilayer film described in the present application may comprise a single polymer, a mixture of a single polymer and non-polymeric material, a combination of two or more polymers blended together, or a mixture of a blend of two or more polymers and non-polymeric material. It will be noted that many polymers may be synthesized by the mutual reaction of complementary monomers. It will also be noted that some polymers are obtained by the chemical modification of other polymers such that the structure of the macromolecules that constitute the resulting polymer may be thought of as having been formed by the homopolymerization of a hypothetical monomer. As used throughout this application, the term “thermoplastic” refers to a polymer or polymer mixture that softens when exposed to heat and then returns to its original condition when cooled to room temperature. In general, thermoplastic materials may include natural or synthetic polymers. Thermoplastic materials may further include any polymer that is cross-linked by either radiation or chemical reaction during manufacturing or post-manufacturing processes. As used throughout this application, the term “polyethylene” or “PE” refers (unless indicated otherwise) to ethylene homopolymers or copolymers. Such copolymers of ethylene include copolymers of ethylene with at least one alpha-olefin and copolymers of ethylene with other units or groups such as vinyl acetate or otherwise. The term “polyethylene” or “PE” will be used without regard to the presence or absence of substituent branch groups. As used throughout this application, the term “low density polyethylene” or “LDPE” refers to branched homopolymers having densities between 0.9 g/cm3 and 0.930 g/cm3, as well as copolymers containing polar groups resulting from copolymerization (such as with vinyl acetate or ethyl acrylate). LDPE typically contains long branches off the main chain (often termed “backbone”) with alkyl substituents of two to eight carbon atoms. As used throughout this application, the term “polyamide” or “PA” or “nylon” refers to a homopolymer or copolymer having an amide linkage between monomer units which may be formed by any method known in the art. The amide linkage can be represented by the general formula: [C(O)—R—C(O)—NH—R′—NH]ₙ where R and R′ are the same or different alkyl (or aryl) group. As used herein, the term “polyolefin” refers to any polymerized olefin that may be linear, branched, cyclic, aliphatic, aromatic, substituted or unsubstituted. More specifically, the term “polyolefin” includes all olefin homopolymers, olefin copolymers, olefin copolymers and olefin copolymerizable olefin comonomer, such as vinyl monomers, their modified polymers, and the like. Specific examples include polyethylene homopolymer, polypropylene homopolymer, polybutene homopolymer, ethylene alpha olefin, which are copolymers of ethylene and one or more alpha olefins such as butene-1, hexene-1, octene-1, and the like. as a comonomer, and the like, a copolymer of propylene and alpha olefin, a copolymer of butene and alpha olefin, a copolymer of ethylene and an unsaturated ester, a copolymer of ethylene and an unsaturated acid (for example, a copolymer of ethylene and etheyl acrylate, a copolymer of ethylene and butyl acrylate, a copolymer ethylene and methyl acrylate, a copolymer of ethylene and acrylic acid and a copolymer of ethylene and methacrylic acid), a copolymer of ethylene and vinyl acetate, an ionomer, poly-metheylpentene, etc. As used herein, the term “anti-tampering” refers to a form suitable for misuse or abuse, opening of a cover

Reference is now made to FIG. 1, schematically illustrating in an out-of-scale manner a cross-section of a tray according to an embodiment of the invention. The package 100 is intact, i.e., was never opened. In this initial closed configuration, a reclosable lid 10 covers a tray 20 having either a lip or a rim portion 21. In this initial configuration, Cover seals the tray hermetically 41 machine-wise in the factory so that isn't any gap between cover and lip. The lid comprises a lidding film 11 which is configured to be disposed on top a sealing area. A visual 1^{st} indication, here a green insignia 33 is provided on top of at least one portion of lip 11. In other words, adjacently stacked blue 31 and yellow 32 layers displays green (33) color.

FIG. 2 schematically depicts a first-time removal of cover 10 from lip 21. Lidding film is peeled up thereby a second insignia (here, blue color 31) is shown on top of tray's lip, and another insignia (here, yellow 32) is shown at the bottom of the cover.

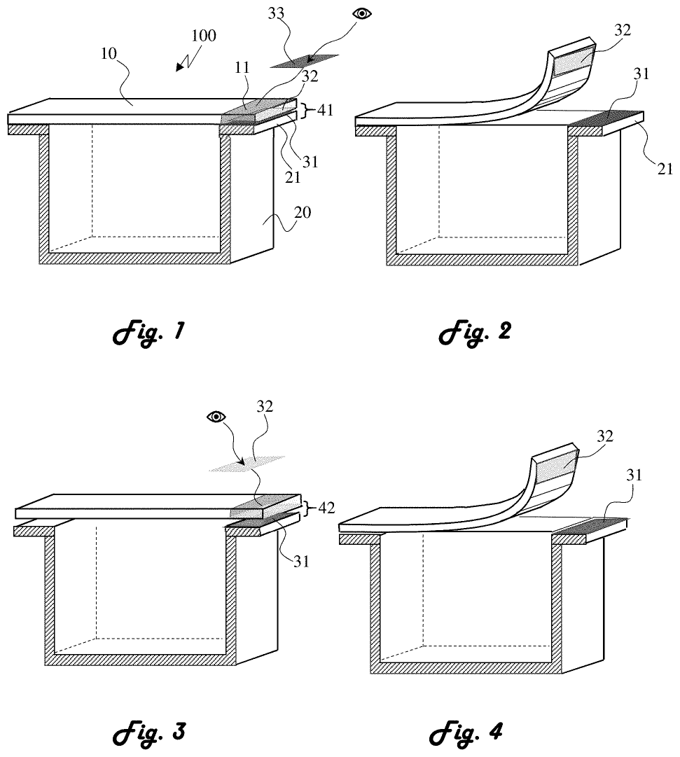

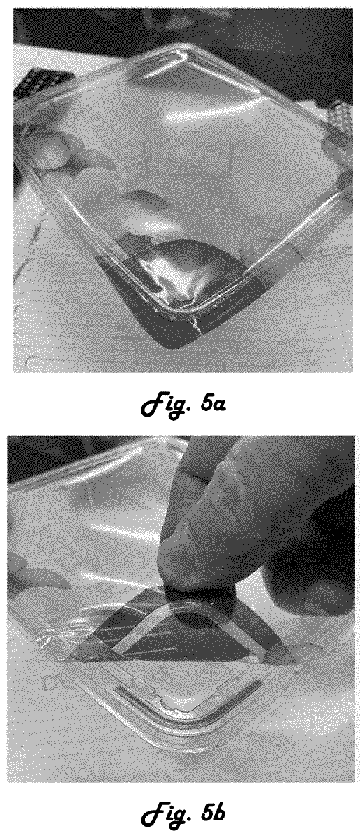

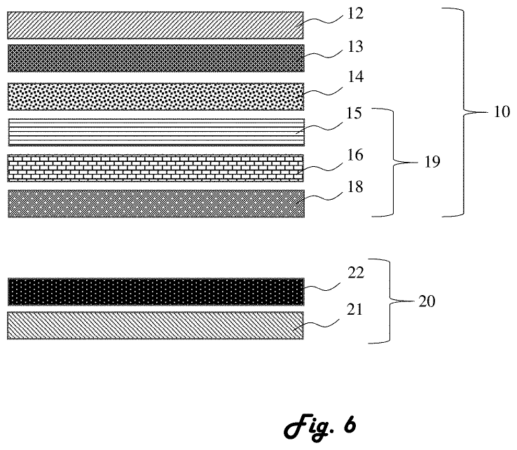

Reference is now made to FIG. 3, schematically illustrating a third configuration of the reclosed package. Here the lidding film is disposed in a loose manner on tray's lip. Now the closure is not hermetic, so that a gap 42 is provided between (blue-) lip 21 and (yellow-) cover's bottom. A second insignia still indicates that the package was tampered, namely, opened before. In other words, blue 31 and yellow 32 layers are not stacked together and only a yellow (32) color is displayed at top portion of the cover. The second insignia (here, yellow 32) will appear along the shelf life of the product in the package even after several opening and closing operations (FIG. 4).

Reference is now made to photos 5a and 5b, showing a reclosable package 100 according to yet another embodiment of the invention, where 5a is the hermetically closed package before opening, and 5b shows the opened package.

In one embodiment of the invention, lidding film comprises multiple layers, e.g., PET; printing ink; adhesive; reclosable sealing layer and printing ink.

FIG. 6 schematically illustrates in a an out-of-scale manner various layers of the cover and the lip according to another embodiment of the invention. Lidding film 10 which reclosably covers tray 20 comprises at top most position, a polymer film (12), such as thermoplastics e.g., PET, PA or POM, about 12 μm. Under PET layer, located a printing ink 13 of about 1 to about 5 μm (e.g., yellow insignia 33) and under that located adhesive layer 14 of about 1.5 to about 5 μm. Under that located a multilayer 19 of about 40-60 μm. Multilayer 19 comprises polyethylene (e.g., LDPE), middle layer being a polymer of reclosable properties, and bottom most layer 18, a sealing layer. Lip 21 of tray 20 is covered by a printing ink 22 (e.g., blue insignia 33).

According to yet another embodiment of the invention, the reclosable adhesive is an olefin-based compound. The adhesive exhibits elastomer-like behavior. the reclosable package comprises a triple-layered film in which the middle layer is an adhesive layer. When first opened, the adhesive layer splits into two adhesive layers: one on the package rim (e.g., a thermoformed box) and the other on the reclosable film. When light force is applied on the film, the two adhesive layers unites to achieve reclosability. Further openings become easier due to already made failure (at the split line).

It is understood that the embodiments of the invention described above are only particular examples which serve to illustrate the principles of the invention. Modifications and alternative embodiments of the invention are contemplated which do not depart from the scope of the invention as defined by the foregoing teachings and appended claims. It is intended that the claims cover all such modifications and alternative embodiments that fall within their scope.

I claim:

1. A tamper-evident reclosable package (100) characterized by a reclosable lidding film 10 configure by means of shape and size to cover a matching tray 20 that having a lip or rim 21; said reclosable lid 10 is a multilayered flexible film comprises at top most position, a transparent layer (12); at least one first printing ink 13 underneath; adhesive layer 14; a multilayer 19, comprising a polymeric layer of reclosable properties; and bottom most a sealing layer 18; said lip 21 is covered by at least one second printing ink 22.

2. The tamper-evident reclosable package of claim 1, wherein lidding film 10 is a multilayered film comprises a film (12) selected from a group consisting of PET, PA, APET, GPET, PP, BOPP, POM, and any mixture and derivatives thereof.

3. The tamper-evident reclosable package of claim 1, wherein multilayer 19 comprising thermoplastic plastic, including polyethylene and LDPE.

4. The tamper-evident reclosable package of claim 1, wherein at least one of the following is held true:
(a) thickness of the transparent layer 12;
(b) thickness of the at least one first printing ink 13 is ranging from about 1 to about 5 μm is ranging from about 1 to about 5 μm;
(c) thickness of the of the adhesive layer 14 is ranging from about 1.5 to about 5 μm;
(d) total thickness of the multilayer 19 is about 40 to about 60 μm; and
(e) thickness of the at least one second printing ink 22 is ranging from about 1 to about 5 μm.

5. The tamper-evident reclosable package of claim 1, wherein said either or both said first and second insignia are selected from a group consisting of alphanumeric, color(s), barcode, symbol, mark, magnetically readable signal and any combination thereof.

6. A method of manufacturing a tamper-evident reclosable package (100); said method comprise steps of configuring by means of shape and size a reclosable lidding film 10 to cover a matching tray 20 having a lip or rim 21; providing said reclosable lid 10 as a multilayer film comprising a top most transparent layer (12); underneath providing at least one first printing ink 13; adhesive layer 14; a multilayer 19, comprising layer, a polymeric layer of reclosable properties; and bottom most sealing layer 18; and covering at least a portion of said lip 21 by at least one second printing ink 22.

7. The manufacturing method of claim 6, wherein lidding film 10 is a multilayered film comprises a film (12) selected from a group consisting of PET, PA, APET, GPET, PP, BOPP, and any mixture and derivative thereof.

8. The manufacturing method of claim 6, wherein multilayer 19 comprising thermoplastic plastic, including polyethylene and LDPE.

9. The tamper-evident method of claim 6, wherein at least one of the following is held true:
(a) thickness of the transparent layer 12;
(b) thickness of the at least one first printing ink 13 is ranging from about 1 to about 5 μm is ranging from about 1 to about 5 μm;
(c) thickness of the of the adhesive layer 14 is ranging from about 1.5 to about 5 μm;
(d) total thickness of the multilayer 19 is about 40 to about 60 μm;
(e) thickness of the at least one second printing ink 22 is ranging from about 1 to about 5 μm.

10. The manufacturing method of claim 6, wherein said either or both said first and second insignia are selected from a group consisting of alphanumeric, color(s), barcode, symbol, mark, magnetically readable signal and any combination thereof.

11. A method of indicating of tampering of a reclosable package (100); said method comprising steps
a. providing a reclosable lidding film 10, configured by means of shape and size to cover a matching tray 20 having a lip or rim 21; said reclosable lidding film 10 is a multilayer comprises at top most position, a transparent layer (12); at least one first printing ink 13 underneath; adhesive layer 14; a multilayer 19 comprising a polyolefin-based layer, a polymeric layer of reclosable properties; and bottom most a sealing layer 18; said lip 21 covered by at least one second printing ink 22;
b. at an initial configuration provided mechanically in the factory, hermetically sealing tray 20 by said lidding film; thereby stacking said at least one first printing ink having a first insignia with said at least one second printing ink having a second insignia; so that said first and second insignia are concurrently provided a first visual indication of “non-tampered” at top of at least one portion of lip 11;
c. at a second configuration, peeling said lidding film, at a first time, from at least one portion of said lip; and
d. at a third configuration, when lidding film is reclosing said tray in a non-hermetically manner, so gap 42 showing said second insignia as said second visual indication of “tampered” (i.e., opened) at top of at least one portion of lip 11.

12. The tamper-evident method of claim 11, wherein lidding film 10 is a multilayered film comprises a film (12) selected from a group consisting of PET, PA, APET, GPET, PP, BOPP, POM, and any mixture and derivative thereof.

13. The tamper-evident method of claim 11 wherein multilayer 19 comprising thermoplastic plastic, including polyethylene and LDPE.

14. The tamper-evident method of claim 6, wherein at least one of the following is held true:
(a) thickness of the transparent layer 12;
(b) thickness of the at least one first printing ink 13 is ranging from about 1 to about 5 μm is ranging from about 1 to about 5 μm;
(c) thickness of the of the adhesive layer 14 is ranging from about 1.5 to about 5 μm;
(d) total thickness of the multilayer 19 is about 40 to about 60 μm; and
(e) thickness of the at least one second printing ink 22 is ranging from about 1 to about 5 μm.

15. The tamper-evident method of claim 11, wherein said either or both said first and second insignia are selected from a group consisting of alphanumeric, color(s), barcode, symbol, mark, magnetically readable signal and any combination thereof.
